(19) United States
(12) Patent Application Publication
(10) Pub. No.: US 2005/0144931 A1
(43) Pub. Date: Jul. 7, 2005

(54) INTEGRAL HEAT RECOVERY DEVICE

(76) Inventors: Stephen M. Floyd, Brentwood, NH (US); Andrew J. Olsen, Amesbury, MA (US)

Correspondence Address: MICHAEL BEST & FRIEDRICH, LLP, 100 E WISCONSIN AVENUE, MILWAUKEE, WI, 53202, US

(21) Appl. No.: 10/712,459

(22) Filed: Nov. 13, 2003

(51) Int. Cl. F02C 7/10

(52) U.S. Cl. 60/39.511

(57) ABSTRACT

A heat exchange device suited for use with a microturbine engine that includes a recuperator that discharges a flow of exhaust gas during operation. The device includes a heat exchanger housing having a first aperture, a second aperture, and a third aperture. A heat exchanger is coupled to the heat exchanger housing adjacent the third aperture. A control member is coupled to the heat exchanger housing and is movable between a first position and a second position. The control member is operable to direct the flow of waste gas from the first aperture, through the heat exchanger, and to the third aperture when in the first position, and from the first aperture to the third aperture when in the second position.

### BACKGROUND

The present invention relates to a combustion turbine engine suited to the cogeneration of heated water. More particularly, the present invention relates to a microturbine engine that can be selectively used for cogeneration.

Microturbine engines are relatively small and efficient sources of power. Microturbines can be used to generate electricity and/or to power auxiliary equipment such as pumps or compressors. When used to generate electricity, microturbines can be used independent of the utility grid or synchronized to the utility grid. In general, microturbine engines are limited to applications requiring 2 megawatts (MW) of power or less. However, some applications larger than 2 MWs may utilize a microturbine engine.

Microturbine engines typically exhaust gas that includes a substantial amount of “waste heat”. This “waste heat” can be used for the cogeneration of heated water before it is finally exhausted to the atmosphere. Current cogenerating microturbine engines duct the exhaust gas through a second heat exchanger to heat water or another fluid. The exhaust gas is then discharged to the atmosphere. During periods when cogeneration is not needed, a small flow of fluid is maintained within the second heat exchanger for cooling purposes. The hot exhaust gas typically passes through at least a portion of the second heat exchanger during all operating modes.

### SUMMARY

The present invention provides a microturbine engine comprising a combustor operable to produce a flow of hot products of combustion and a turbine rotating in response to the flow of hot products of combustion therethrough. The turbine discharges a flow of hot exhaust gas and a recuperator receives the flow of hot exhaust gas and discharges a flow of waste gas. A heat exchanger housing receives the flow of waste gas and includes a first flow path and a second flow path. A heat exchanger is disposed within the first flow path and a control member is supported by the heat exchanger housing and movable between a first position and a second position. When the control member is disposed in the first position, the flow of waste gas is directed along the first flow path. When the control member is disposed in the second position, the flow of waste gas is directed along the second flow path.

In another aspect, the invention provides a heat exchange device suited for use with a microturbine engine that includes a recuperator that discharges a flow of exhaust gas during operation. The device includes a heat exchanger housing having a first aperture, a second aperture, and a third aperture. A heat exchanger is coupled to the heat exchanger housing adjacent the third aperture. A control member is coupled to the heat exchanger housing and is movable between a first position and a second position. The control member is operable to direct the flow of waste gas from the first aperture, through the heat exchanger, and to the third aperture when in the first position, and from the first aperture to the third aperture when in the second position.

In yet another aspect, the present invention provides a method of controlling a temperature of a flow of fluid in a heat exchanger using a microturbine engine. The method includes operating the engine to produce a flow of hot gas and passing the hot gas through a recuperator to heat a flow of compressed air. The method also includes discharging a flow of exhaust gas from the recuperator and directing the flow of exhaust gas to a control member. The method further includes positioning the control member to direct a desired portion of the flow of exhaust gas through a heat recovery device and passing the flow of fluid through the heat recovery device. The method also includes sensing the temperature of the flow of fluid and moving the control member to a new position between a first position and a second position in response to the sensed temperature.

### BRIEF DESCRIPTION OF THE DRAWINGS

The description particularly refers to the accompanying figures in which:

FIG. 1 is a perspective view of a portion of a microturbine engine;

FIG. 2 is a perspective view of a portion of the microturbine engine including a second heat exchanger;

FIG. 3 is a perspective view of a heat exchanger duct;

FIG. 4 is a perspective view of a second heat exchanger;

FIG. 5 is a side view of the heat exchange duct of FIG. 4 including a damper in the open position; and

FIG. 6 is a side view of the heat exchange duct of FIG. 4 including the damper in the closed position.

Before any embodiments of the invention are explained, it is to be understood that the invention is not limited in its application to the details of construction and the arrangements of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof is meant to encompass the items listed thereafter and equivalence thereof as well as additional items. The terms “connected,” “coupled,” and “mounted” and variations thereof are used broadly and encompass direct and indirect connections, couplings, and mountings. In addition, the terms “connected” and “coupled” and variations thereof are not restricted to physical or mechanical connections or couplings.

### DETAILED DESCRIPTION

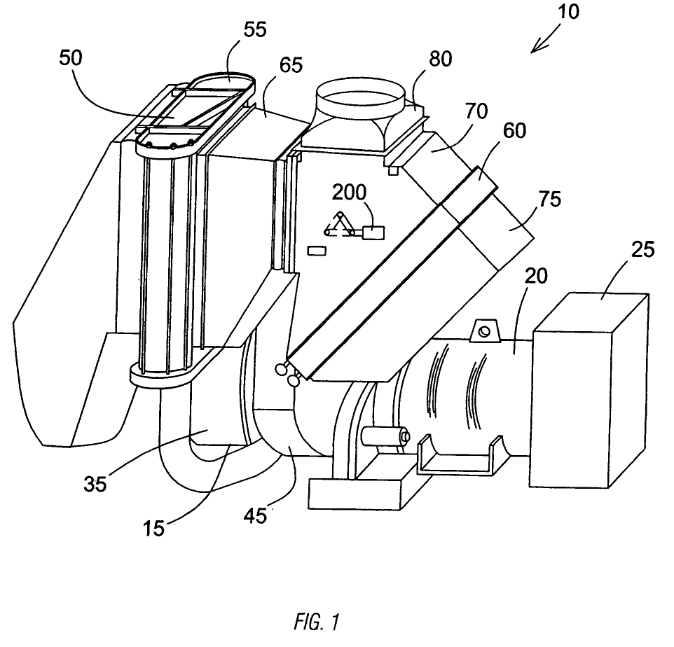

With reference to FIG. 1, a microturbine engine system 10 that includes a turbine section 15, a generator section 20, and a control system 25 is illustrated. The turbine section 15 includes a radial flow turbine 35, a compressor 45, a recuperator 50, and a combustor 55. The recuperator 50 may be of the plate-fin variety with the combustor 55 in the inlet manifold as disclosed in U.S. Pat. No. 5,450,724, the entire contents of which is incorporated herein by reference.

The engine 10 includes a standard Brayton cycle combustion turbine with the recuperator 50 added to improve engine efficiency. The engine shown is a single-spool engine (one set of rotating elements). However, multi-spool engines are also contemplated by the invention. The compressor 45 is a centrifugal-type compressor having a rotary element that rotates in response to operation of the turbine 35. The compressor 45 shown is a single-stage compressor. However, multi-stage compressors can be employed where a higher pressure ratio is desired. Alternatively, compressors of different designs (e.g., axial-flow compressors, reciprocating compressors, and the like) can be employed to supply compressed air to the engine.

The turbine 35 is a radial flow single-stage turbine having a rotary element directly coupled to the rotary element of the compressor 45. In other constructions, multi-stage turbines or other types of turbines may be employed. The coupled rotary elements of the turbine 35 and the compressor 45 engage the generator section 20. In some constructions, the coupled rotary elements engage a gearbox or other speed reducer disposed between the turbine section 15 and the generator section 20.

The recuperator 50 includes a heat exchanger employed to transfer heat from a hot fluid to the relatively cool compressed air leaving the compressor 45. One suitable recuperator 50 is described in U.S. Pat. No. 5,983,992 fully incorporated herein by reference. The recuperator 50 includes a plurality of heat exchange cells stacked on top of one another to define flow paths therebetween. The cool compressed air flows within the individual cells, while a flow of hot exhaust gas passes between the heat exchange cells.

During operation of the microturbine engine system 10, the rotary element of the compressor 45 rotates in response to rotation of the rotary element of the turbine 35. The compressor 45 draws in atmospheric air and increases its pressure. The high-pressure air exits the air compressor 45 and flows to the recuperator 50.

The flow of compressed air, now preheated within the recuperator 50, flows to the combustor as a flow of preheated air. The preheated air mixes with a supply of fuel within the combustor 55 and is combusted to produce a flow of products of combustion. The use of a recuperator 50 to preheat the air allows for the use of less fuel to reach the desired temperature within the flow of products of combustion, thereby improving engine efficiency.

The flow of products of combustion enters the turbine 35 and transfers thermal and kinetic energy to the turbine 35. The energy transfer results in rotation of the rotary element of the turbine 35 and a drop in the temperature of the products of combustion. The energy transfer allows the turbine 35 to drive both the compressor 45 and the generator 20. The products of combustion exit the turbine 35 as a first exhaust gas flow.

In constructions that employ a second turbine, the first turbine 35 drives only the compressor, while the second turbine drives the generator 20 or any other device to be driven. The second turbine receives the first exhaust flow, rotates in response to the flow of exhaust gas therethrough, and discharges a second exhaust flow.

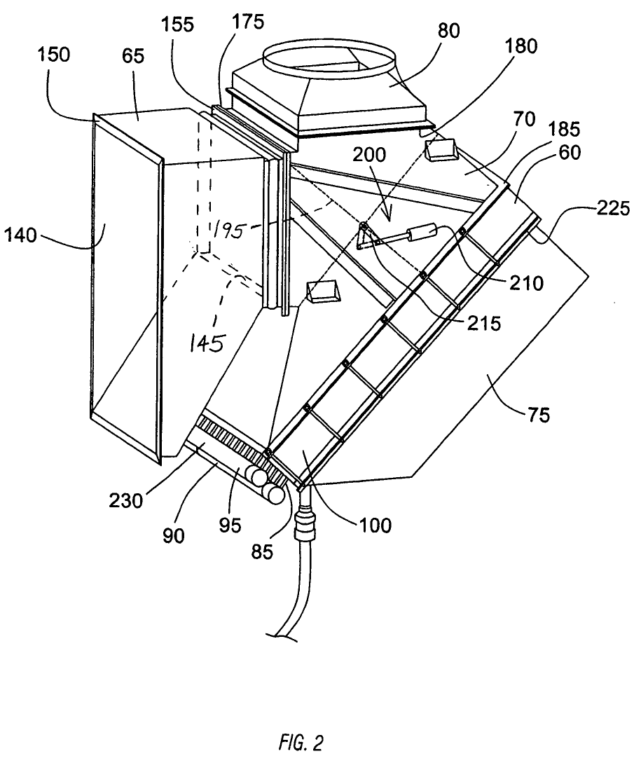

The first exhaust flow, or second exhaust flow in two turbine engines, enters the flow areas between the heat exchange cells of the recuperator 50 and transfers excess heat energy to the flow of compressed air. The exhaust gas then exits the recuperator 50 and is discharged to the atmosphere, processed, or further used as desired (e.g., cogeneration using a second heat exchanger 60 as shown in FIGS. 1 and 2).

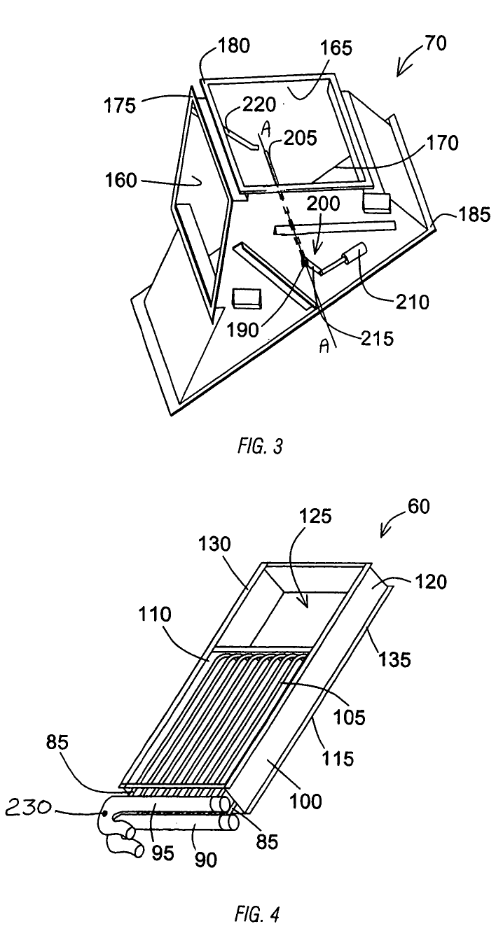

Turning to FIG. 2 a portion of the microturbine engine 10 is illustrated as including the heat exchanger 60, an exhaust plenum 65, a heat exchanger duct 70, a bottom cover 75, and an exhaust cover 80. The heat exchanger 60, illustrated in FIG. 4, is a fin-tube heat exchanger with other heat exchanger designs (e.g., plate-fin, shell-tube, and the like) also being suited to operation with the present invention. A plurality of tubes 85 carry a fluid, such as water, while hot exhaust gas flows past the fins and the outer surface of the tubes 85. The fluid within the tubes 85 is heated by the exhaust gas and the exhaust gas is cooled somewhat before it is discharged to the atmosphere. The heat exchanger 60 includes an inlet manifold 90 in the form of a first large pipe and an outlet manifold 95 in the form of a second large pipe disposed adjacent a lower end 100 of the heat exchanger 60. The tubes 85 penetrate each of the manifolds 90, 95 to distribute and collect water to/from the various tubes 85 that make up the heat exchanger 60. The various tubes 85 define a heat exchanger core 105 that includes a gas inlet 110 and a gas outlet 115.

The core 105 is supported within a frame 120 that includes an open bypass window 125. Gas flow through the core 105 heats the fluid flowing through the tubes 85, the flow then returns through the open window 125. In another construction, the core 105 extends the full length of the frame 120 and no open window 125 is provided.

The frame 120 includes an inlet attachment flange 130 adjacent to, and at least partially surrounding, the gas inlet side 110 of the core 105 and an outlet attachment flange 135 adjacent to, and at least partially surrounding, the gas outlet side 115 of the core 105.

Returning to FIG. 2, the exhaust plenum 65 is shown as including a large inlet opening 140 and a smaller outlet opening 145. Both openings 140, 145 are substantially rectangular in shape with the inlet opening 140 being substantially surrounded by a plenum inlet flange 150 and the outlet opening 145 being substantially surrounded by a plenum outlet flange 155. The flanges 150, 155 include a substantially flat surface and a plurality of holes that facilitate sealing and assembly respectively.

The inlet flange 150 attaches to the exhaust side of the recuperator 50, thereby allowing the recuperator 50 to deliver the flow of exhaust gas to the inlet opening 140. Each of a plurality of bolts extends through one of the holes in the inlet flange 150 to attach the exhaust plenum 65 to the recuperator 50. In some constructions, a gasket (e.g., spiral-wound metallic, soft metal, fiber, and the like) is positioned between the recuperator 50 and the exhaust plenum 65 to improve the seal and inhibit leakage between the components 50, 65.

While bolts have been described as the fastener, other methods of connecting the two components 50, 65 are possible. For example, the two components 50, 65 could be welded to one another. Alternatively, a clamping system could be employed to clamp the inlet flange 150 to the recuperator 50. As such, the invention should not be limited to the use of fasteners alone. In addition, the invention should not be limited to rectangular openings alone. While rectangular openings are easily produced during the manufacture of the exhaust plenum 65, other shape openings such as circular or oval are also well suited to the present application.

The heat exchanger duct 70, illustrated in FIG. 3, includes a first aperture 160, a second aperture 165, and a third aperture 170. The first, second, and third apertures 160, 165, 170 are each at least partially surrounded by a first, second, and third attachment flange 175, 180, 185 respectively. The first, second, and third attachment flanges 175, 180, 185 are similar to the inlet and outlet flanges 150, 155 of the exhaust plenum 65. The first attachment flange 175 is sized to align with the outlet flange 155 of the exhaust plenum 65. The flanges 155, 175 at least partially surround the first aperture 160 and the outlet opening 145 such that the apertures 145, 160 align with one another and provide for the delivery of the exhaust gas from the exhaust plenum 65 to the heat exchanger duct 70. Again, bolts are used to facilitate the attachment, with other attachment methods (e.g., welding, clamping, screwing, and the like) also being suited to the task. In addition, a suitable gasket may be provided between the two components 65, 70 to improve the seal and inhibit leakage of exhaust gas out of the engine 10.

The second aperture 165 provides for an exhaust gas outlet from the engine 10. The second aperture 165 is positioned near the top of the heat exchanger duct 70 such that the escaping exhaust gas can travel away from the engine 10. The exhaust cover 80 attaches to the second flange 180 that at least partially surrounds the second aperture 165 and acts to direct the exhaust gas in the desired direction. The exhaust cover 80 may include a nozzle, guide vanes, or other flow manipulating devices that act to direct or change the flow as desired. For example, a nozzle could be used to accelerate the flow and better disperse the exhaust gas into the atmosphere.

The third attachment flange 185 is sized and shaped to mate with the inlet attachment flange 130 of the heat exchanger frame 120. As previously described, bolts facilitate the attachment of the components 60, 70 with other methods also suited to the task. In addition, a gasket may be used to improve the seal between the two components 60, 70 if desired. The heat exchanger frame 120 surrounds the entire third aperture 170 to force the exhaust gas to pass through the heat exchanger core 105 and return through the window 125 to reach the third aperture 170.

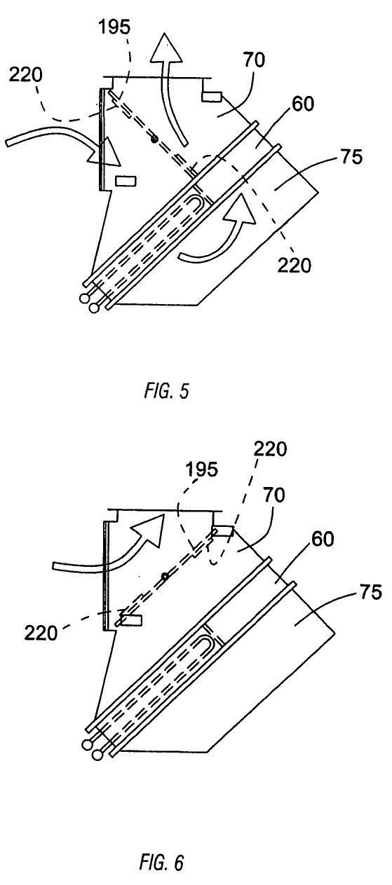

With continued reference to FIG. 3, the heat exchanger duct 70 also includes a through bore 190 that defines a damper axis A-A, a damper 195 (illustrated in FIGS. 5 and 6), and a damper drive 200. The through bore 190 is positioned to support an axle 205 that supports the damper 195 within the heat exchanger duct 70 such that the damper 195 is movable between an open position (illustrated in FIG. 5) and a closed position (illustrated in FIG. 6). The axle 205 (shown with the damper 195 removed in FIG. 3) passes through the bore 190 and supports the damper 195 for rotation about the damper axis A-A. In some constructions, bearings (e.g., roller bearings, needle bearings, pillow-block bearings, and the like) are positioned at either end of the axle 205 to reduce the force required to move the damper 195.

The damper drive 200 includes an actuator, such as a hydraulic or pneumatic cylinder 210, that is movable between an extended position (shown in broken line in FIGS. 1-2) and a retracted position. The cylinder 210 drives a lever arm 215 that fixedly attaches to the axle 205 to rotate the damper 195. Thus, when the cylinder 210 is extended, the damper 195 is in the open position (FIG. 5) and when the cylinder 210 is retracted, the damper 195 is in the closed position (FIG. 6). In other constructions, retraction of the cylinder 210 opens the damper 195, while extension of the cylinder 210 closes the damper 195. In still other constructions, a rotary actuator, such as an electric motor is used to move the damper 195. As one of ordinary skill will realize, many different actuators could be used to position the damper 195 as desired. In addition, a manual mechanism, such as a hand wheel, could be used rather than a powered actuator. As such, the present invention should not be limited to the few actuators described herein.

The heat exchanger duct 70 also includes a plurality of seal members 220 attached to the inner surface of the duct 70. The seal members 220 of the illustrated embodiment are pieces of angle iron that engage the damper 195 in its extreme opened or closed position and provide a seal between the damper 195 and the side walls of the heat exchanger duct 70.

As shown in FIG. 2, the bottom cover 75 attaches to the outlet flange 135 of the heat exchanger frame 120 to enclose the various exhaust gas flow paths. The bottom cover 75 includes a single large opening that is at least partially surrounded by a cover flange 225. The cover flange 225 engages the outlet flange 135 of the heat exchanger frame 120 adjacent the outlet side 115 of the heat exchanger core 105. Like the other attachments, bolts or any suitable attachment method can be used. In addition, a gasket may be positioned between the heat exchanger frame 120 and the bottom cover 75 to inhibit unwanted leakage.

In some constructions, the bottom cover 75 includes flow guides or vanes that direct the flow in the desired direction. However, the invention will function without these components.

In operation, the turbine engine 10 operates to produce electricity. As a byproduct of operation, the engine 10 produces a significant volume of hot exhaust gas. The hot exhaust gas exits the recuperator 50 and flows into the exhaust plenum 60. With the damper 195 configured in the open position (as shown in FIG. 5), the exhaust gas is directed through the heat exchanger core 105 to heat a flow of fluid passing through the tubes 85 of the heat exchanger 60. The damper 195 provides a movable wall within the heat exchanger duct 70 that directs the exhaust gas through the heat exchanger core 105 and inhibits flow directly to the exhaust cover 80. After passing through the heat exchanger core 105, the exhaust gas collects in the bottom cover 75 and is redirected through the window 125 in the frame 120. From the window 125, the flow re-enters the heat exchanger duct 70 on the opposite side of the damper 195 as it entered. The flow then proceeds out of the engine 10 through the exhaust cover 80.

In constructions that employ a heat exchanger core 105 that extends the full length of the frame 120, the hot exhaust flow passes through the heat exchanger core 105 twice. First, the flow passes through the core 105 to the bottom cover 75, which redirects the flow as previously described. However, rather than passing through an open window 125, the flow again passes through the heat exchanger core 105.

The fluid being heated by the exhaust gas (e.g., water) passes through the tubes 85 and is heated by the flow of exhaust gas through the core 105. In many applications, the flow of exhaust gas is able to heat the flow of water by 20 degrees F. or more.

In many constructions, a temperature sensor 230 (e.g., thermocouple, temperature switches, thermistors, resistance temperature detectors, optical pyrometers, radiation thermometers, and the like) is positioned to measure the temperature of the fluid exiting the tubes 85. This temperature value is compared with a temperature set point that is input by an operator to calculate a temperature error. The position of the damper 195 is automatically adjusted by the control system in response to the temperature error to achieve the desired fluid temperature at the exit of the tubes 85. For example, if the set point temperature is 180° F. and the exit temperature of the fluid is measured at 200° F., the control system will signal the damper drive 200 to move the damper 195 toward the closed position. Moving toward the closed position allows addition exhaust gas to bypass the heat exchanger core 105, thereby lowering the fluid temperature at the exit of the tubes 85. In this manner, the microturbine engine 10 is able to generate both usable electricity and a flow of fluid at a desired elevated temperature.

It should be clear from the foregoing that damper 195 can be positioned anywhere between the full open and the full closed position. The ability to position the damper 195 as desired allows for the fine tuning of the outlet temperature of the water being heated.

In other constructions, the damper position is set regardless of the measured temperature. This results in the substantially uncontrolled heating of the fluid passing through the tubes 85 of the heat exchanger core 105.

To discontinue cogeneration, the cylinder 210 moves the damper 195 to the closed position. In the closed position, the damper 195 blocks flow to the heat exchanger 60 or from the window 125. As such, the exhaust gas exiting the exhaust plenum 65 flows directly to the exhaust cover 80 and out of the engine 10. Because the hot exhaust gas does not flow through any part of the heat exchanger core 105, the core 105 remains relatively cool and there is no need for coolant flow. In addition, because a relatively light damper 195 moves rather than the heat exchanger core 105, smaller actuators can be used with increased reliability.

Although the invention has been described in detail with reference to certain preferred embodiments, variations and modifications exist within the scope and spirit of the invention as described and defined in the following claims.

1. A microturbine engine comprising:
a combustor operable to produce a flow of hot products of combustion;
a turbine rotating in response to the flow of hot products of combustion therethrough, the turbine discharging a flow of hot exhaust gas;
a recuperator receiving the flow of hot exhaust gas and discharging a flow of waste gas;
a heat exchanger housing receiving the flow of waste gas and including a first flow path and a second flow path;
a heat exchanger disposed within the first flow path; and
a control member movable between a first position and a second position, such that when the control member is disposed in the first position the flow of waste gas is directed along the first flow path and when the control member is disposed in the second position the flow of waste gas is directed along the second flow path.

2. The microturbine engine of claim 1, wherein the turbine includes a radial flow turbine.

3. The microturbine engine of claim 1, wherein the heat exchanger includes a finned-tube heat exchanger.

4. The microturbine engine of claim 1, wherein the heat exchanger is supported within a frame, and the frame attaches to the heat exchanger housing.

5. The microturbine engine of claim 4, wherein the frame defines an open window and wherein the flow of waste gas passes through the heat exchanger in a first direction and passes through the open window in a second direction substantially opposite the first direction when the control member is in the first position.

6. The microturbine engine of claim 1, wherein the control member includes a damper rotatable about an axis in response to movement of an actuator.

7. The microturbine engine of claim 6, wherein the actuator includes a hydraulic cylinder.

8. The microturbine engine of claim 1, wherein a fluid flows within the heat exchanger, the microturbine further comprising a sensor measuring the temperature of the fluid.

9. The microturbine engine of claim 8, further comprising an actuator operable to move the control member in response to the measured temperature.

10. A heat exchange device suited for use with a microturbine engine that includes a recuperator that discharges a flow of exhaust gas during operation, the device comprising:
a heat exchanger housing having a first aperture through which the flow of exhaust gas enters the housing, and a second aperture through which the exhaust gas exits the housing;
a heat exchanger within the heat exchanger housing; and
a control member movable between a first position and a second position, the control member directing the flow of exhaust gas from the first aperture, through the heat exchanger, and to the second aperture when in the first position, and from the first aperture to the second aperture substantially without flowing through the heat exchanger when in the second position.

11. The heat exchange device of claim 10, wherein the heat exchanger includes a finned-tube heat exchanger.

12. The heat exchange device of claim 10, wherein the heat exchanger is supported within a frame, and the frame attaches to the heat exchanger housing.

13. The heat exchange device of claim 12, wherein the frame defines an open window and wherein the flow of waste gas passes through the heat exchanger in a first direction and passes through the open window in a second direction substantially opposite the first direction when the control member is in the first position.

14. The heat exchange device of claim 10, wherein the control member includes a damper rotatable about an axis in response to movement of an actuator.

15. The heat exchange device of claim 14, wherein the actuator includes a hydraulic cylinder.

16. The heat exchange device of claim 10, wherein a fluid flows within the heat exchanger, the microturbine further comprising a sensor measuring the temperature of the fluid.

17. The heat exchange device of claim 16, further comprising an actuator operable to move the control member in response to the measured temperature.

18. A method of controlling a temperature of a flow of fluid in a heat exchanger using a microturbine engine, the method comprising:
operating the engine to produce a flow of hot gas;
passing the hot gas through a recuperator to heat a flow of compressed air;
discharging a flow of exhaust gas from the recuperator;
directing the flow of exhaust gas to a control member;
positioning the control member to direct a desired portion of the flow of exhaust gas through a heat recovery device;
passing the flow of fluid through the heat recovery device;
sensing the temperature of the flow of fluid; and
moving the control member to a new position between a first position and a second position in response to the sensed temperature.

19. The method of claim 18, further comprising setting a set point temperature and comparing the set point temperature to the temperature of the flow of fluid.

20. The method of claim 18, wherein the positioning the control member step further includes moving a hydraulic actuator.
